(19) United States
(12) Patent Application Publication
(10) Pub. No.: US 2002/0188428 A1
(43) Pub. Date: Dec. 12, 2002

(54) Delivery and display of measurement instrument data via a network

(76) Inventor: Paul G. Faust, Fort Collins, CO (US)

Correspondence Address: AGILENT TECHNOLOGIES, INC., Legal Department, DL429, Intellectual Property Administration, P.O. Box 7599, Loveland, CO, 80537-0599, US

(21) Appl. No.: 09/876,541

(22) Filed: Jun. 7, 2001

(51) Int. Cl. G06F 11/00

(52) U.S. Cl. 702/188

(57) ABSTRACT

A client/server arrangement which allows measurement instruments to transmit measurement data to a client in lieu of image data. Measurement data is preferably raw digitized data which has been acquired from a signal source. The transmission of measurement data via the client/server arrangement results in the transmission of much less data over a network, and results in the faster transmission of data. Given the greater and faster resources that a client such as a personal computer or workstation might have, the client will often be able to generate and update a waveform display faster than the measurement instrument. The client can also generate displays which differ from that displayed by the measurement instrument. Furthermore, the client can generate multiple displays from the same measurement data, and different clients can generate different displays.

### FIELD OF THE INVENTION

The invention pertains to the delivery and display of measurement instrument data via a network.

### BACKGROUND OF THE INVENTION

A measurement instrument is defined herein to be any instrument which acquires data for such purposes as data monitoring, data processing, data evaluation or data analysis. Measurement instruments therefore comprise such instruments as oscilloscopes, logic analyzers, spectrum analyzers, network analyzers, AC power source/analyzers, cardiographs, patient telemetry systems, and respiratory and metabolic analyzer. Measurement instrument data is defined herein as any data which is acquired and/or generated by a measurement instrument.

A measurement instrument typically comprises leads, probes and/or connectors (collectively referred to herein as “leads”), as well as a number of controls. The controls often take the form of knobs, buttons, sliders and the like which provide a user with an ability to manually adjust instrument configuration parameters such as frequency response, sample rate sweep, baseline, method of displaying data, and so on.

When using a measurement instrument to acquire data, its lea need to be coupled or otherwise exposed to the source of a phenomenon which the instrument is to measure. Often, the acquisition of data via a measurement instrument requires adjustments in the placement of a instrument's leads, as well as adjustments in the instrument's configuration parameters. To facilitate such adjustments, a measurement instrument will typically comprise some sort of graphical rendering capability, as well as a dedicated display screen on which acquired and/or generated data can be displayed for viewing. In this manner, a user may 1) view the quality and/or existence of data which is being acquired by the instrument, 2) manually adjust the instrument's leads and/or configuration parameters as necessary, and 3) get instant feedback as to the effect of his or her adjustments via the instrument's dedicated display. Although a measurement instrument does not necessarily need to have a dedicated display, dedicated displays are common since many measurement instruments are used in the field, and the need to view data in the field makes dedicated displays practical.

Although a measurement instrument often requires some decree of “onsite” configuration, situations frequently arise wherein it is desire to alter an instrument's configuration parameters and/or view an instrument's acquired data “offsite”. For example, an engineer might want to submit a device to a series of tests, which series of tests will take hours, days or even weeks to complete. Such a lengthy series of tests is especially likely when a measurement instrument is coupled to a device under test via a programmable test fixture, wherein the instrument's data inputs may be selectively coupled to various nodes of the device under test.

As another example of when it might be desirable to alter an instrument's configuration and/or view an instrument's acquired data offsite, consider a technician or plant engineer who wants to monitor the output of a signal or process, which signal or process is expected to change, but at an unknown time. In a similar vein, a physician or nurse might want to monitor a patient's heartbeat, respiratory pattern, or metabolic data from a location which is down the hall or otherwise distant from a patient's room.

As a final example of when it might be desirable to alter an instrument's configuration and/or view an instrument's acquired data offsite, consider a situation wherein unexpected data is being acquired from a device under test, patient or other source, and it is desired to transmit the instrument's data and configuration parameters to an expert or specialist in a particular field for further analysis. In the medical field in particular, remotely located medical facilities, paramedics working in the field, and others are relying on online diagnoses made by doctors viewing instrument data over an Internet connection.

While various means for configuring a measurement instrument from a remote location exist, relatively fewer means exist for delivering measurement instrument data to a remote location. Typically, these means operate by incorporating a network server into a measurement instrument (or by providing a proxy server computer) for acquiring data from the measurement instrument. The server acquires data from the instrument in response to a client's request for the data, and then delivers its acquired data to the client.

The data which an instrument's server provides to a client generally consists of bitmap image data such as GIF (graphics interchange format) or HP-GL (Hewlett-Packard Graphics Language) data. Typically, a measurement instrument just dumps its screen image to a graphics file on a periodic basis. These graphics files are then provided to a client which has requested the data via the instrument's server. Unfortunately, each of the screen images may comprise a lot of data. For example, a single screen image of a spectrum analyzer might be dumped to a bitmap file having a size on the order of 130 kilobytes. Since a spectrum analyzer might, for example, acquire data at the rate of 26.5 GHz and display data at the rate of 5 MHz, one can appreciate that the generation of graphics files in response to a spectrum analyzer's displayed screen images presents a significant processing burden, much or all of which would need to be absorbed by the spectrum analyzer's own processing resources. As explained below, the absorption of this additional processing burden is difficult for many instruments.

Since their inception, there has been a concerted effort to increase the rates at which many measurement instruments acquire, store, process and display data. To achieve such aspirations, engineers have developed, for example, high speed data acquisition interfaces, high speed analog-to-digital converters, faster processors, and deeper acquisition memories. At the same time, there has been an effort to increase the functionality measurement instruments. Thus, many measurement instruments have migrated to alternate display formats, color displays, greater data sensitivity, more and varied data analysis options, the ability to deliver data over a network, and so on. The sum effect of all of these improvements has been to increase the processing burden which is placed on a measurement instrument, as well as the cost of the measurement instrument.

The further expansion of an instrument's processing powers to enable its support of network data delivery is troublesome, as any additional increase in an instrument's cost is undesirable. Likewise, any detraction from an instrument's performance is undesirable. As a result, a measurement instrument's ability to deliver data via a network is what suffers. Typically, only 1/nth of a measurement instrument's screen images are saved to graphics files and made available for network data delivery. The opportunity for an offsite data viewer to miss a critical event is therefore significant. Occasionally, an instrument is programmed to deliver a greater number of images to a network client. However, the processing burden for doing so often requires a relief of processing burdens elsewhere, such as by reducing the rate at which an instrument acquires data. The net effect is thus the same, with the update rate and/or granularity of data which is ultimately presented to a remote viewer being the element that suffers.

### SUMMARY OF THE INVENTION

In addition to poor update rate and/or data granularity, current means for delivering measurement instrument data via a network present additional problems and/or disadvantages. First, the speed at which relatively large graphics files can be transferred over a network can lead to further reductions in data update rate and granularity. Second, a remote viewer of instrument data is forced to view data in more or less the same format as it would appear on a measurement instrument's dedicated display screen, even though the client computer is likely to have much greater processing capabilities than the measurement instrument (and might be able to display data in a more convenient or enlightening format). Third, even though a remote viewer of instrument data may be provided with some degree of control over an instrument's configuration (e.g., an ability to transmit configuration commands to the instrument via a network), the remote viewer is forced to view the same data which appears on the instrument's screen, and the same data which appears on any other remote viewer's screen. Thus, different remote viewers cannot view and analyze an instrument's data in different ways. Different viewing and analysis options would be useful, for example, if 1) two different remote viewers were analyzing the sane data for different purposes, or 2) two different remote viewers were accustomed to viewing data (or trained to view data) in different formats.

In accordance with the invention, new methods and apparatus for viewing measurement instrument data are disclosed herein. A common theme to the methods and apparatus is that they only require the transmission of measurement data over a network, rather than thy transmission of image data. Measurement data is that data which is acquired by an instrument for future processing, analyzing, viewing and the like, whereas image data is data which has already been processed for the purpose of generating a screen image. Measurement data and image data will be collectively referred to herein as instrument data (or measurement instrument data).

While a single screen image which is generated by a spectrum analyzer might comprise 130 kilobytes of data, the measurement data which serves as a basis for generating the screen image may comprise only 1600 bytes of data (i.e., 1.6 kilobytes of data). As a result, measurement data may be transmitted over a network at much faster rates. Furthermore, the processing burden which the transmission of measurement data places on a measurement instrument is small. Finally, the vast reduction in the processing burden which is placed on an instrument, combined with the much greater speeds at which data may be transmitted over a network, allow one to consider transmitting more measurement data over a network (and possibly even more data than would otherwise be displayed on a measurement instrument's own display screen). Thus, instruments with deep memories can transmit greater amounts of data for display on a remote screen than could otherwise be processed and displayed on the instrument's own screen.

By way of example, a first preferred method for viewing measurement data comprises programming a measurement instrument to acquire measurement data and provide the measurement data to a server. The server is then programmed to transmit the measurement data to a client. Finally, the client is programmed to render a graphical display of the measurement data.

A second preferred method for viewing measurement data comprises programming a measurement instrument with graphical rendering capability to acquire measurement data and provide the measurement data to a server. The server is then programmed to transmit the measurement data to a client. Finally, the client is programmed to render a graphical display of the measurement data, wherein the graphical rendering undertaken by the client is independent of any graphical rendering undertaken by the measurement instrument.

Also by way of example, a first preferred embodiment of apparatus for displaying measurement data comprises a number of computer readable media with program code stored thereon. The program code comprises program code for displaying command entry elements and display preference elements through a graphical user interface. The commend entry elements are provided for receiving instrument commands from a user and the display preference elements are provide for receiving display preferences from a user. The program also comprises program code for transmitting the instrument commands to a measurement instrument. Additionally, the program code comprises program code for graphically rendering measurement data which is received from a measurement instrument, with the rendering being performed at least partly in response to a user's selected display preferences.

The important advantages and objectives of the above and other embodiments of the invention will be further explained in, or will become apparent from, the accompanying description, drawings and claims.

### BRIEF DESCRIPTION OF THE DRAWINGS

Illustrative and presently preferred embodiments of the invention are illustrated in the drawings, in which:

FIG. 1 illustrates a first exemplary client/server relationship between a measurement instrument and a remote computer;

FIG. 2 illustrates a second exemplary client/server relation hip between a measurement instrument and a remote computer;

FIG. 3 illustrates a third exemplary client/server relationship between a measurement instrument and a remote computer;

FIG. 4 illustrates a standard display of measurement data on he remote computer of FIGS. 1-3;

FIG. 5 illustrates a command entry pop-up window which can be derived from the web page illustrated in FIG. 4.

### DESCRIPTION OF THE PREFERRED EMBODIMENT

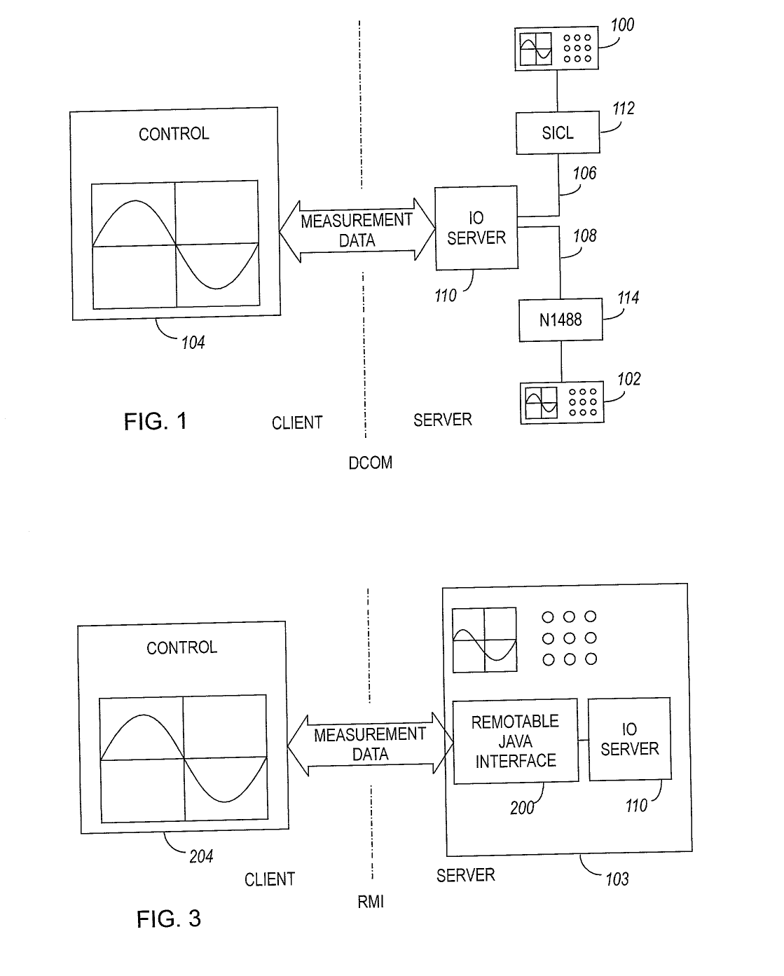

FIG. 1 illustrates a first preferred client/server relationship between a measurement instrument 100 or 102 and a remote computer 104. The measurement instrument 100, 102 may take a variety of forms, including that of various waveform measurement instruments such as: oscilloscopes, logic analyzers, spectrum analyzers, network analyzers, AC power source/analyzers, or medical instruments (e.g., cardiographs, patient telemetry systems, or respiratory or metabolic analyzers).

The instrument 100, 102 may comprise any one or more of a number of different output buses, including a General-Purpose Interface Bus (GPIB), a VME Extensions for Instrumentation bus (VXI bus), an RS-232 serial bus, a universal serial bus (USB), or Institute of Electrical and Electronics Engineers 1394 bus (IEEE-1394 bus).

An appropriate cable (e.g., an RS-232 106 or GPIB 108 cable) couples the instrument 100, 102 to an Input/Output Server (I/O Server) 110.

The I/O Server 110 may be instrument specific, such as an I/O Server which communicates with a specific instrument (e.g., the Agilent Technologies E4407B ESA-E Series Portable Spectrum Analyzer or instrument class (e.g., GPIB spectrum analyzers). Alternatively, the I/O Server 110 may be of a universal design, as taught in the United States patent application of Faust et al. entitled “Universal I/O Interface” (Ser. No. 09/275,276 filed Mar. 23, 1999).

One purpose of the I/O Server 110 is to receive byte streams of commands via a particular network protocol, and then transmit the byte streams of commands to a measurement instrument 100 in a form which may be understood by the measurement instrument 100. For example, when necessary, the I/O Server 110 might unwrap received byte streams of commands (e.g., SCPI commands) so as to hide network protocol specifics from a measurement instrument 100.

Another purpose of the I/O Server 110 is to receive requests for instrument data over a network connection, read acquired byte streams of data from an instrument 100, prepare the data for transmission via 3 particular network protocol, and then transmit the data to a client or group of clients which requested the data.

In some cases, the I/O Server 110 might determine how to process and/or format byte streams which are transmitted over the bus by referencing an I/O Software Library such as the Agilent Technologies Standard Instrument Control Library (SICL) 112. If the I/O Server 110 is coupled to an instrument 102 via a GPIB cable, the I/O Server 110 might also determine how to process and/or format byte streams which are transmitted over the bus by referencing the National Instruments 438 (NI488) library 114.

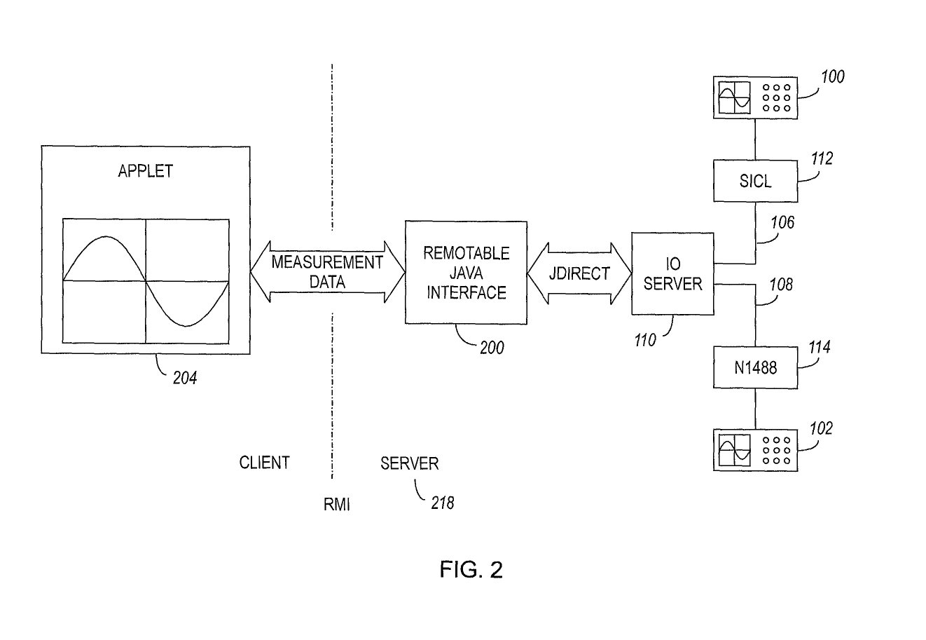

In FIG. 1, the I/O Server 110 is implemented using COM (Component Object Model) objects, and Microsoft's Distributed Component Object Model (DCOM) specification is used as a basis for transmitting data between the I/O Server 110 and a client 104 (via a network connection such as a LAN (local area network) or Internet connection). However, DCOM is not platform independent. FIG. 2 therefore shows an embodiment of the invention wherein an I/O Server 110 communicates with a client 204 using Java's Remote Method Invocation (RMI). Java is platform independent.

To facilitate the client/server configuration illustrated in FIG. 2 the I/O Server 110 communicates with a client 204 via a Remotable Java Interface 200. Data transfers between the Remotable Java Interface 200 and I/O Server 110 may be made using the JDirect protocol. JDirect is a communication protocol developed by Microsoft. Alternatively, a Java Native Interface (JNI) protocol could be used in lieu of the JDirect protocol. JNI is a communication protocol developed by Sun Microsystems.

The Remotable Java Interface 200 is a Java class that extends UnicastRemote, throws remote exceptions, and exposes data in a form which is more compatible in Java (e.g., it performs marshaling and unmarshaling). The structure of the Remotable Java Interface 200 is largely defined by the Java language.

The client 104, 204 with which the I/O Server 110 communicates may be hosted by the same computer which hosts the I/O Server 110, or may be hosted by a remote client computer. The client 204 is preferably a Java applet, ActiveX control, plug-in, or other application which is designed to interface with a web browser such as Internet Explorer or Netscape Communicator. However, the client 104, 204 may also be a stand-alone application. In a preferred embodiment, the client is a “thin client”, with data reduction and processing being largely or entirely performed by the I/O Server 110 or yet another server (not shown).

With respect to the client 204 illustrated in FIG. 2, Java's AWT (Abstract Windowing Toolkit) or Swing graphical user interface too kits may be used to render a graphical display of measurement data which is received by the client 204. AWT and Swing are libraries of Java graphical user interfaces (GUIs) that provide connections between a Java application and the native GUI (e.g., a web browser) on which the Java application runs.

The I/O Server 110 and Remotable Java Interface 200 may be hosted by a server computer which services a measurement instrument 100, by a client computer, or by a measurement instrument 100 (though it is sometimes preferable that the I/O Server 110 and Remotable Java Interface 200 be distinct from the measurement instrument 100 so that the measurement instrument 100 does not have to devote resources to the processing burden which the I/O Server 110 and Remotable Java Interface 200 might impose on the measurement instrument 100). The I/O Server 110 and Remotable Java Interface 200 are shown to be hosted by a measurement instrument 103 in FIG. 3. Note that an advantage to client/server relationship illustrated in FIG. 3 is that there is no need for an 110 cable 106,108 or I/O Software Library 112,114. Furthermore, there is no need for an additional computer on the instrument side for the purpose of hosting the I/O Server 110 and Remotable Java Interface 200. Also, since the Remotable Java interface 200 is incorporated into the instrument 100, the Remotable Java Interface 200 can become the programming model for the instrument 100 in lieu of a typical string based protocol and interface such as GPIB or RS-232.

Similarly to the location of the I/O Server 110 and Remotable Java Interface 200, the location of the client 104, 204 may vary as necessary. While it is a basic principle of the invention that the client 104, 204 not be hosted by the measurement instrument 100, the client 104, 204 may be hosted by a computer which serves the afore-mentioned server and Java interface purposes. However, in most cases the client 104, 204 will be hosted by a computer which is remote from both the measurement instrument 100, the I/O Server 110, and if provided, the Remotable Java Interface 200. Regardless of the physical locations of the client 104, 204, I/O Server 110, and Remotable Java Interface 200, the client 104, 204 will preferably communicate with the I/O Server 110 or Remotable Java Interface 200 via a network protocol such as TCP/IP or NetBEUI.

In the remainder of this description, the I/O Server 110 and Remotable Java Interface 200 will often be referred to collectively as a server 218.

In general, two forms of data flow between a client 104, 204, server 110, 218, and measurement instrument 100, 102: commands and data. Commands typically flow from a client 104, 204 to a measurement instrument 100, 102, whereas data typically flows from a measurement instrument 100, 102 to a client 104, 204.

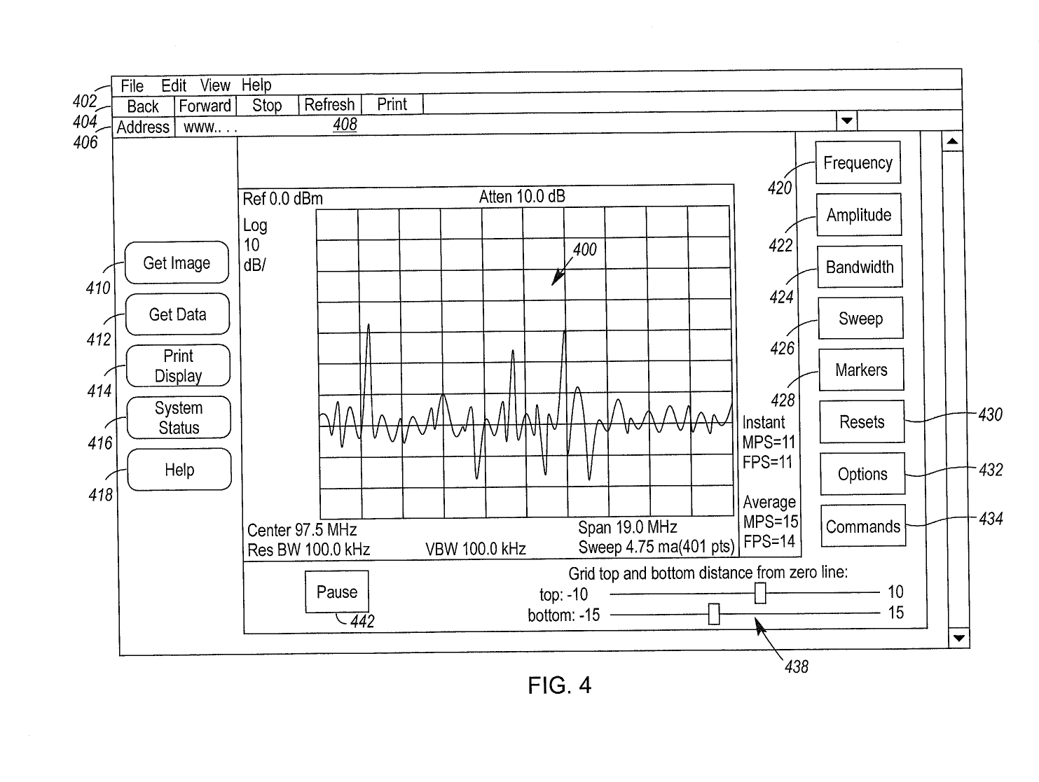

Commands may take a variety of forms, depending on the exact nature of a measurement instrument 100. If the instrument 100 is a spectrum analyzer, for example, the commands may comprise SCPI commands. As will be explained shortly, the client 104, 204 preferably displays a graphical user interface 400 (FIG. 4) through which commands may be entered. Entered commands may then be transmitted to a measurement instrument 100 via the measurement instrument's servers 110, 218, to thereby 1) configure parameters of the measurement instrument 100 from a possibly remote location, or 2) request data from the measurement instrument 100. As will be discussed further, later in this description, a client's knowledge of its transmitted configuration commands may assist the client 104 in rendering a graphical display of measurement data.

Data may also take a variety of forms, but typically comprises data which is transmitted from an instrument 100, 102 to a client 104, 204 via the instrument's servers 110, 218. Data which is transmitted from instrument to client will be referred to generally herein as “instrument data” or “measurement instrument data”. Instrument data may also take a variety of forms. In the past, instrument data which has been transmitted over a network has largely consisted of “image data”. That is, a measurement instrument 100 has periodically dumped an image displayed on its external display screen to its output bus, and the image has then been transmitted over a network connection to a client 104, 204 which has requested the image. Unfortunately, such an image transfer process necessitates the transfer of large amounts of data. For example, the transfer of a conventional spectrum analyzer screen image might require a transfer of 130 kilobytes (130 kb) of data. The generation and transfer of this amount of data places a significant processing burden on an instrument 100. As a result, an instrument 100 will typically only be able to generate and transmit a relatively few number of screen images to a client 104, 204. It is therefore difficult for a client 104, 204 to display data in real-time. Not only is the client's display likely to appear choppy, but the fact that a client 104, 204 is only able to display 1/nth of the images which are displayed by an instrument 100 means that there is a high probability that a viewer of the client's displayed mages will miss short but critical events which are acquired and displayed on a measurement instrument's own display.

In accordance with the invention, “measurement data” is transmitted by a measurement instrument 100 in lieu of image data. Measurement data, in general, is data which an instrument 100 acquires from a signal source. Measurement data is preferably raw digitized data which has been acquired from a signal source, but may comprise data which has been converted or pre-processed prior to a measurement instrument's generation of image data. Measurement data may also comprise configuration parameters, such as settings under which signal data was acquired (scale factors; baselines; settings of an instrument's knobs, sliders, and buttons (whether programmed or manually input to an instrument 104); etc.).

Measurement data is transmitted to a client 104, 204 (via a server 110, 218 or servers) in response to commands which are issued by the client 104, 204, such as commands to transmit signal data, or command which query an instrument's configuration parameters. Measurement data comprising configuration parameters may be used by a client 104, 204 to assist in its rendering of a graphical display.

Measurement data is much more compact than image data because it provides coordinates for discrete points in a signal waveform (e.g., spectrum analyzer measurement data might comprise a number of corresponding amplitude and frequency readings, while other measurement data might comprise corresponding time and decibel readings, etc.). Image data, on the other hand, must comprise data for lighting every pixel on a display screen, which data often comprises graticule data, marker data, text data, color data, intensity data, GUI data, and so on. The measurement data which is used to generate portions of the afore-mentioned 130 kb spectrum analyzer screen image might consist of only 1600 bytes of data (i.e., 1.6 kb; or two orders of magnitude less data than the spectrum analyzer's image data). Such a savings in the amount of data which a measurement instrument 100 needs to transmit to a client 104, 204 provides numerous advantages.

A first advantage of smaller data transmissions is that the transmission processing burden which is placed on an instrument 100 is greatly reduced. A measurement instrument 100 can therefore provide data to its servers 110, 218 more quickly, and with more regularity. Likewise, if a measurement instrument can prepare data for transmission more quickly and more regularly, a client 104, 204 is likely to receive transmitted date more quickly and regularly. The ability of a client 104, 204 to display data in real-time is therefore increased. Items such as graticule data, marker data, text data, color data, intensity data, GUI data, and so on may be generated and displayed by a client 104, 204.

The transmission of measurement data may also relieve the data processing burden of some instruments 100, 102. That is, many measurement instruments 100, 102 have their own graphical rendering capability, and some of these measurement instruments 100, 102 have the ability to cease generating screen images when, for example, their dedicated displays are turned off. As a result, the display of an instrument 190 which sits in a lab which is visited infrequently may be turned off, thus freeing up a greater percentage of the instrument's processing resources for acquiring and transmitting data to one or more remote clients 104, 204.

Another advantage of smaller data transmissions is that freed processing resources may be used to 1) acquire data at a higher sample rate, and/or 2) transmit more of an instrument's acquired data to a client 104, 204. These actions respectively increase the likelihood that a measurement instrument 100 will capture a fleeting signal event, and increase the likelihood that the fleeting event will be broadcast to a client 104, 204 for display. The availability and transmission of more data to a client 104, 204 also increases the potential granularity and update rate of a client's display, thus enhancing a remote user's ability to view high-resolution data in real-time.

The above advantages of transmitting measurement data in lieu of image data are derived from the fact that measurement data packets are much smaller than image files. However, additional advantages are derived from the mere fact that measurement data is sent to a client 104, 204 in lieu of image data.

By sending measurement data to a client 104, 204, the client 104, 204 is free to generate a display which differs from that of an instrument's own display (i.e., an “alternate visualization”). In other words, the graphical rendering which is undertaken by a client 104, 204 is independent of that which is undertaken by a measurement instrument 100. For example, a client 104, 204 might desire to display a waveform with markers while at the same time a measurement instrument 100 is displaying a waveform without markers. However, given that a client 104, 204 may be a high-end personal computer or workstation which has significantly more and faster resources than an instrument 100, even more pronounced differences between the displays of an instrument 100 and client 104, 204 may be achieved.

Yet another advantage of transmitting measurement rather than image data over a network is that a client 104 running on a remote personal computer and receiving measurement data from an instrument 109 over a simple dial-up Internet connection (or simple LAN connection) has a high probably of being able to display and update data on a screen faster than an instrument 100 can display and update the same data on its own screen. The advantages of offloading image processing duties from a measurement instrument are even more pronounced when a client 104 is instantiated on a current model workstation which, for example, receives data over a digital subscriber line (DSL), T-1, or high-speed local area network (LAN) connection.

Another advantage of transmitting measurement data between an instrument and one or more clients is that a single client may be programmed to simultaneously render alternate displays of the same measurement data, or multiple clients may be programmed to render alternate displays of the same measurement data. In the latter case, different viewers of measurement data may independently view the same data in different or individually preferred viewing formats, and all viewers are not committed to the viewing preferences of a single, master viewer (i.e. the graphical rendering undertaken by any particular client is independent of that undertaken by any other client, and independent of the viewing limitations of a measurement instrument). For example, the same or different clients might simultaneously display waveform data with differing sets of markers. Likewise, one client might display a grid, while a measurement instrument or another client does not. Colors schemes which are displayed by two different clients could also differ.

A measurement instrument 100, server 110, 218 and client 104, 204 may be programmed to perform the above tasks, either independently and/or with user input, via a number of computer readable media having program code stored thereon. The media may comprise magnetic media such as floppy disks or magnetic tapes, optical media such as compact discs (CDs), hard disks, etc. The program code stored thereon may comprise software (e.g., C++ program code, Java program code, etc.), firmware, etc. Depending upon its end-use, and the manner in which it is sold, the program code may be embodied in 1) a single application, or 2) a collection of applications, applets or the like which are designed to interface with one another. For example, the program code may be sold as a single application (e.g., packaged and/or sold as a single unit, or under a single license) which may be loaded onto a client 104, 204. The single application may then communicate not only with the client 104, 204, but also with a measurement instrument 100 via its servers 110, 218, to accomplish programming of same. Alternately, the single application may distribute portions of its code to the measurement instrument 100 and/or its servers 110, 218 so that the distributed portions may run locally on the measurement instrument 100 and/or its servers 110, 218 as the client portions of the application communicate with same. As another example, portions of the program code may be pre-loaded onto a client 104, 204, measurement instrument 100 and measurement instrument servers 110, 218 so that portions of the program code may be sold with a physical piece of hardware. When one has upgraded a system to include all portions of the hardware (e.g., a client computer 104, a measurement instrument 100, and a server 218), the program code may then be used for its intended purposes.

By way of example, FIG. 4 illustrates an exemplary screen image of one of the clients 104, 204 shown in FIGS. 1-3. The screen image may be displayed by a variety of applications, one of which will be describe later in this description. In a preferred embodiment, the screen image includes a variety of controls, some of which are peculiar to the application which generates the screen image (e.g., controls 402-418), and some of which are peculiar to controlling a particular measurement instrument 100 from which the application draws measurement data for displaying a waveform (e.g., controls 420-434, 438, 442). Note that unlike past applications, which have displayed waveforms as portions of screen images received from a measurement instrument 100, the application which displays the screen image shown in FIG. 4 utilizes measurement data (e.g., amplitude and frequency readings) to display a waveform 400. Thus, the application which displays the FIG. 4 screen image determines the content and format of the various items displayed therein. In fact, even the method of displaying the waveform 400 is controlled by the application. This is possible because the application does not receive a waveform as part of an image, but rather receives only measurement data from which a waveform image may be created. Although the application does not rely on measurement instrument image data for creating a screen image, the application may receive configuration parameters from a measurement instrument 100 (e.g. in response to queries for same), and/or may rely on configuration commands which the application transmits to a measurement instrument 100, to assist the application in rendering a graphical display of measurement data and/or a screen image.

Although the screen image shown in FIG. 4 displays only on view of measurement data (i.e., a single waveform 400), even such a simple display is advantageous over what has been done before when a client 104, 204 and/or an instrument's servers 110, 218 are able to generate the waveform 400 displayed therein in lieu of a measurement instrument 100 generating same. In fact, even when a client 104, 204 is programmed to mimic the display which a measurement instrument 100 is capable of generating, advantages may be obtained by offloading any graphical rendering tasks from the measurement instrument 100.

As previously alluded to, the waveform 400 which forms pa of the screen image illustrated in FIG. 4 may be displayed by a variety of applications. However, by way of example, the waveform 400 is shown to be displayed by a web browser. Although the web browser interface which is illustrated in FIG. 4 is generic in form, one of ordinary skill in the a will readily appreciate that the items displayed in FIG. 4 could be displyed through any available web browser (such as Microsoft® Internet Explorer or Netscape® Navigator®).

As shown in FIG. 4, in addition to displaying a waveform 400, the web browser may also display elements of a graphical user interface. As taught below, user input to these elements may be utilized to program the client 104, 204 itself, a measurement instrument 100, or a measurement instrument's servers 110, 218.

The upper two rows of text 402, 404 which form part of the web browser interface illustrated in FIG. 4 display various conventional toolbar buttons such as File, Edit View, Help, Back, Forward, Stop, Refresh and Print buttons. Each of these buttons may be depressed to activate its associated function by using an input device (e.g., a mouse, trackball or pen tablet) which is designed for navigating over a graphical user interface. The third row of text 406 which forms part of the web browser interface illustrated in FIG. 4 displays a text box 408 for entering the address of a web page, file or device (e.g., a measurement instrument 100).

A variety of buttons 410-418 which are specific to the page of data specified in the text box 408 are displayed on the lefthand side of the web browser interface. The Print Display 414 and Help 418 buttons are self explanatory. The Get Image 410 and Get Data 412 buttons respectively correspond to the functions of acquiring image data from a measurement instrument 100 or acquiring measurement data from a measurement instrument 100. If the Get Image button 410 is depressed, then the image displayed between the lefthand 410-418 and righthand 420-434 buttons of the page being displayed by the web browser will be derived from an image which is generated by a selected measurement instrument 100. If the Get Data button 412 is depressed, then the image displayed between the lefthand 410-418 and righthand 420-434 buttons of the page being displayed by the web browser will be generated from data which is transmitted from a measurement instrument 100 prior to the instrument's generation an image which is based on the data. In this latter case, the image which is displayed by the web browser is preferably generated by the computer on which the web browser is running.

The System Status button 416 can provide, for example, 1) indications as to which clients 104, 204 are connected to an instrument 100, or 2) performance characterizations of measurements which are being transferred to a client 104, 204, etc. Performance characterizations may comprise information such as how many traces are being displayed or acquired per second. The System Status button 416 may also provide information which can assist a user in diagnosing issues pertaining to connecting to a measurement instrument server 110, 218.

Additional buttons 420-434 which are specific to the page of data specified in the text box 408 are displayed on the righthand side of the web browser interface. Many of these buttons are peculiar to the particular type of measurement instrument 100 from which the web browser is receiving data. For example, if the instrument 100 is a spectrum analyzer, these buttons might comprise Frequency 420, Amplitude 422, Bandwidth 4 Sweep 426, Markers 428, Resets 430 and Options 432 buttons. Depressing one of these buttons 420-432 generates, for example, a pop-up window which provides functionality similar to that which is provided by the buttons, sliders and other controls which are often found on the face of a measurement instrument 100.

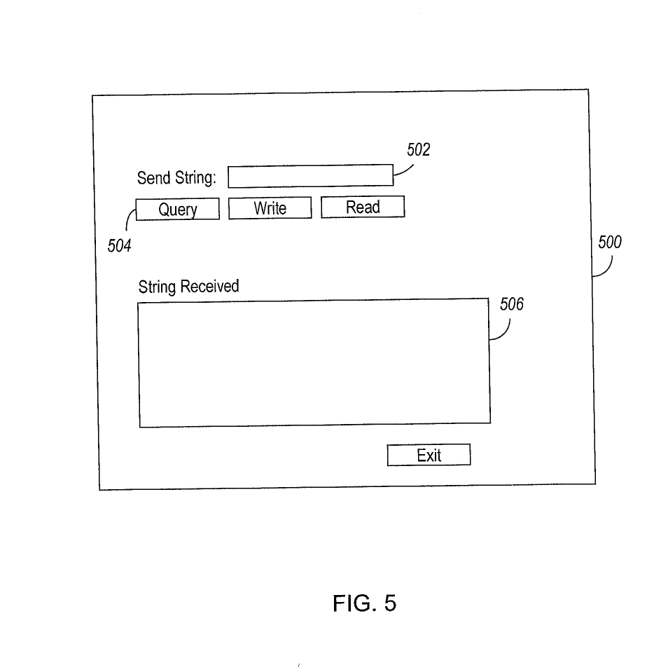

Depressing the Commands button 434 generates, for example, a popup window 500 (FIG. 5) with a text box 502 or selection screen through which various instrument configuration commands may be entered and/or selected. Entered or selected commands may then be transmitted to an instrument 100 through the instrument's servers 110, 218. The Pop-up window 500 may further comprise a window 506 for displaying pare meters, acknowledgments, and other data which are received by a client in response to transmitting an instrument command or commands (or in response to querying 504 the instrument for same).

The lower portion of the web browser interface shown in FIG. 4 displays controls 438, 442 which may be operated for the purpose of scaling a grid, or pausing the update of a display.

Buttons 420-434 may function as display preference element and/or command entry elements of a web browser. Thus, depending on the programming of a client 104, 204, the buttons 420-434 may serve to 1) receive display preferences from a user for the purpose of programming a client 104, thereby changing the content of data displayed through a web browser, and/or 2) receive instrument commands from a user for the purpose of programming an instrument 100 or its servers 110, 218, thereby influencing the configuration of same (including the data transmitted by same). Note that like display preferences, instrument commands may also influence a client's display of measurement data.

While illustrative and presently preferred embodiments of thy invention have been described in detail herein, it is to be understood that the inventive concepts may be otherwise variously embodied and employed, and that the appended claims are intended to be construed to include such variations, except as limited by the prior art.

What is claimed is:

1. A method for viewing measurement data, comprising:
a) programming a measurement instrument to acquire measurement data and provide the measurement data to a server;
b) programming the server to transmit the measurement data to a client; and
c) programming the client to render a graphical display of the measurement data.

2. A method as in claim 1, wherein the graphical display rendered by the client is a real-time display.

3. A method as in claim 1, wherein the measurement data comprises corresponding amplitude and frequency readings.

4. A method as in claim 1, wherein the measurement data comprises corresponding time and decibel readings.

5. A method as in claim 1, further comprising programming the client to simultaneously render alternate displays of the measurement data.

6. A method as in claim 1, further comprising:
a) programming the server to transmit the measurement data to at least one additional client; and
b) programming the at least one additional client to render a graphical display of the measurement data, wherein a graphical rendering undertaken by a particular one of the at least one additional client is independent of any graphical rendering undertaken by the measurement instrument, and independent of any graphical rendering undertaken by any other client.

7. A method as in claim 1, wherein the client is programmed to mimic any graphical rendering undertaken by the measurement instrument.

8. A method as in claim 1, further comprising programming the client to transmit configuration commands to the measurement instrument, wherein said client's knowledge of its transmitted configuration commands assists the client in rendering said graphical display of said measurement data.

9. A method as in claim 1, further comprising programming the client to query the measurement instrument for various configuration parameters, wherein said measurement instrument's response to said query assists the client in rendering said graphical display of said measurement data.

10. A method as in claim 1, further comprising programming said client to display a graphical user interface, wherein said instrument, server and client programming steps are responsive to user input provided through said graphical user interface.

11. A method for viewing measurement data, comprising:
a) programming a measurement instrument with graphical rendering capability to acquire measurement data and provide the measurement data to a server;
b) programming the server to transmit the measurement data to a client; and
c) programming the client to render a graphical display of the measurement data, wherein said graphical rendering undertaken by the client is independent of any graphical rendering undertaken by the measurement instrument.

12. A method as in claim 11, wherein the graphical display rendered by the client is a real-time display.

13. A method as in claim 11, wherein the measurement instrument is a waveform measurement instrument.

14. A method as in claim 13, wherein the measurement instrument is a spectrum analyzer.

15. A method as in claim 13, wherein the measurement instrument is an oscilloscope.

16. A method as in claim 11, wherein the measurement instrument is a medical instrument.

17. Apparatus for displaying measurement data, comprising:
a) a number of computer readable media; and
b) program code stored in said number of computer readable media, said program code comprising:
i) program code for displaying command entry elements and display preference elements through a graphical user interface, wherein said command entry elements are provided for receiving instrument command, from a user, and wherein said display preference elements are provided for receiving display preferences from a user;
ii) program code for transmitting said instrument commands to a measurement instrument; and
iii) program code for graphically rendering measurement data received from said measurement instrument, said rendering being performed at least partly in response to said display preferences.

18. Apparatus as in claim 17, wherein said program code for grapically rendering measurement data performs said rendering at least partly in response to said instrument commands.

19. Apparatus as in claim 17, wherein measurement data is obtained, and instrument commands are transmitted, by the apparatus using Remote Method Invocation.

20. Apparatus for displaying measurement data, comprising:
a) means for programming a measurement instrument to transmit measurement data to a client; and
b) means for programming the client to display the measurement data in real-time.
